(19) United States
(12) Patent Application Publication
(10) Pub. No.: US 2026/0274420 A1
(43) Pub. Date: Sep. 17, 2026

(54) OPTIMIZATION OF AN OPEN ROTOR PROPULSION SYSTEM COMPRISING AN UNDUCTED FAN AND A DUCTED FAN

(71) Applicants: SAFRAN AIRCRAFT ENGINES, Paris (FR); GENERAL ELECTRIC COMPANY, Schenectady, NY (US)

(72) Inventors: Maxime Paul Numa GIVERT, Solers, Île-de-France (FR); Paul Ghislain Albert LEVISSE, Paris, Île-de-France (FR); Olivier BELMONTE, Cely en Bière, Île-de-France (FR); Romuald Muriel GENTILS, Ozoir la Ferrière, Île-de-France (FR); Maeva Daphné GROS-BOROT, Paris, Île-de-France (FR); Alexandre Clément Pascal CLERC-COSTES, Lyon, Auvergne-Rhône-Alpes (FR); Olivier FORMICA, Combs-la-Ville, Île-de-France (FR); Romain TRUCO, Guibeville, Île-de-France (FR); Amit ZUTSHI, Evendale, OH (US); Narayanan PAYYOOR, Bengaluru, Karnataka (IN); Sivakumar MAHESH, Bengaluru, Karnataka (IN); Darek ZATORSKI, Evendale, OH (US)

(73) Assignees: SAFRAN AIRCRAFT ENGINES, Paris (FR); GENERAL ELECTRIC COMPANY, Schenectady, NY (US)

(21) Appl. No.: 19/471,582

(22) PCT Filed: Apr. 11, 2023
(86) PCT No.: PCT/US2023/018147

§ 371 Date: Oct. 1, 2025

(51) Int. Cl. B64D 27/12; B64D 27/40; B64D 35/00; B64F 5/40; F02C 7/06; F16C 19/49; F16C 33/38

(52) U.S. Cl. CPC B64D 27/12; B64D 27/402; B64D 35/00; B64F 5/40; F02C 7/06; F16C 19/49; F16C 33/38; F05D 2220/36; F05D 2230/70; F16C 2360/23

(57) ABSTRACT

An open rotor propulsion system includes a fan section including an unducted rotating element and a non-rotating stationary element, a forward frame housing an inlet duct, a ducted fan positioned within the inlet duct, a fan duct and a core duct extending aft the ducted fan, an engine positioned within the core duct and including low-and high-pressure compressors, an intermediate case between the low-and high-pressure compressors, a fan drive turbine and a shaft to drive the ducted fan, and four bearings that support the shaft. The four bearings include a first bearing connected to the forward frame or the intermediate case, and a second bearing aft of the first bearing and including a gravity center axially positioned between a first plane that includes a gravity center of the low-pressure compressor and a second plane that includes a gravity center of the intermediate case.

### TECHNICAL FIELD

The technology described herein relates to open rotor and ducted propulsion systems, and particularly architectures for such systems. The technology is of particular benefit when applied to gas turbine engines for aircraft propulsion.

### BACKGROUND

Gas turbine engines employing an open rotor design architecture are known. A turbofan engine operates on the principle that a central gas turbine core drives a bypass fan, the fan being located at a radial location within a nacelle of the engine and upstream of the engine core such that the fan operates within a “duct” formed by the inner surface of the nacelle but air driven by the fan “bypasses” the central gas turbine core. An open rotor propulsion system instead operates on the principle of having the bypass fan located outside of the engine nacelle, in other words, “unducted”. This permits the use of larger fan blades able to act upon a larger volume of air than for a turbofan engine, and thereby improves propulsive efficiency over conventional ducted engine designs.

Optimum performance has been found with an open rotor design having a fan provided by two contra-rotating rotor assemblies, each rotor assembly carrying an array of airfoil blades located outside the engine nacelle. As used herein, “contra-rotational relationship” means that the blades of the first and second rotor assemblies are arranged to rotate in opposing directions to each other. Typically, the blades of the first and second rotor assemblies are arranged to rotate about a common axis in opposing directions, and are axially spaced apart along that axis. For example, the respective blades of the first rotor assembly and second rotor assembly may be co-axially mounted and spaced apart, with the blades of the first rotor assembly configured to rotate clockwise about the axis and the blades of the second rotor assembly configured to rotate counter-clockwise about the axis (or vice versa). In appearance, the fan blades of an open rotor engine resemble the propeller blades of a conventional turboprop engine.

In order to reduce the complexity of the design, yet yield a level of propulsive efficiency comparable to contra-rotating propulsion designs with a significant weight and length reduction, document US 2021/0108597 proposes a propulsion system comprising a fan section including a rotating element and a stationary element, and an inlet between the rotating element and the stationary element, wherein the inlet passes radially inward of the stationary element. The inlet leads to an inlet duct containing a ducted fan having an axis of rotation and a plurality of blades. Besides, the inlet duct divides into a first duct and a second duct, separate from the first duct. The rotating element of the fan section is driven by a fan drive turbine section through a fan drive shaft.

However, the ducted fan is massive with a large diameter and is subject to external aggressions. It may therefore be unbalanced.

Besides, Applicant discovered that the fan drive turbine shaft of this propulsion system was supercritical. Indeed, the fan drive turbine shaft has at least one flexural mode in its operating range and may resonate during stabilized flight phases. In some cases, the flexural mode of the fan drive turbine shaft may even coincide and couple with a flexural mode of the unbalanced ducted fan (radial translation of the blades of the ducted fan).

### SUMMARY

An objective of the present application is the provision of a propulsion system comprising a fan section including an open rotating element and a ducted fan, having an improved dynamic response in stabilized flight phases, and more particularly wherein the energetic contribution of the ducted fan to the fan drive turbine shaft and the amount of potential energy in the fan drive turbine shaft are reduced.

In that purpose, the present disclosure proposes, according to a first aspect, an open rotor propulsion system comprising:
a fan section including an unducted rotating element comprising a first array of fan airfoil blades and a non-rotating stationary element;
an forward frame housing an inlet duct including an inlet located between the unducted rotating element and the non-rotating stationary element;
a ducted fan positioned aft the unducted rotating element within the inlet duct, wherein the ducted fan comprises a second array of fan airfoil blades;
a fan duct and a core duct extending aft the ducted fan; an engine positioned within the core duct and comprising a low-pressure compressor, a high-pressure compressor, an intermediate case located between the low-pressure compressor and the high-pressure compressor, a fan drive turbine and a shaft connected to the fan drive turbine and configured to drive the ducted fan; and
four bearings configured to support the shaft with respect to an engine case, wherein the bearings comprise:
a first bearing connected to one of the forward frame and the intermediate case; and
a second bearing aft of the first bearing and comprising a gravity center axially positioned between a first plane that comprises a gravity center of the low-pressure compressor and a second plane that comprises a gravity center of the intermediate case.

Preferred but non-limiting features of the open rotor propulsion system according to the first aspect are the following:
the first bearing is positioned radially inwardly of the ducted fan;
the first bearing is connected to the intermediate case;
a gravity center of the first bearing is axially positioned between a third plane that intersects a forwardmost point of a leading edge of the unducted fan and a fourth plane that intersects a downwardmost point of a trailing edge of the unducted fan;
the first bearing is forward of the ducted fan;
the first bearing comprises a roller bearing and the second bearing comprises a ball bearing;
the second bearing includes squirrel cage and a squeeze-film damper;
the gravity center of the second bearing extends between a fifth plane that comprises a gravity center of a rotating part of a last stage of the low-pressure compressor and the second plane;
the open rotor propulsion system further comprising a first support that connects the first bearing to the one of the inlet case and the intermediate case, and a second support that connects the second bearing to the engine case, optionally to the intermediate case, wherein a radial stiffness of the first support is at least twice bigger than a radial stiffness of the second support;
the bearings further comprise: a third bearing positioned radially inwardly of the fan drive turbine; and a fourth bearing, positioned aft of the third bearing;
a gravity center of the third bearing axially extends between a sixth plane that intersects a gravity center of the fan drive turbine and a seventh plane that intersects a rotating part of a stage of the fan drive turbine which is immediately forward of the sixth plane;
the open rotor propulsion system comprising a turbine rear frame aft of the fan drive turbine, wherein the fourth bearing extends radially inwardly of the turbine rear frame;
the open rotor propulsion system further comprises supports that connect the third bearing and the fourth bearing to a turbine rear frame;
the open rotor propulsion system further comprises a high-pressure turbine that drives the high-pressure compressor and an inter-turbine case that extends between the high-pressure turbine and the fan drive turbine, wherein a gravity center of the third bearing axially extends between a eighth plane that intersects a forward portion of the inter-turbine case and a nineth plane that intersects a rotating part of a first stage of the fan drive turbine;
a gravity center of the fourth bearing extends between a sixth plane that intersects gravity center of the fan drive turbine and a tenth plane that intersect a forwardmost portion of a turbine rear frame;
the open rotor propulsion system further comprises a third support that connects the third bearing to the inter-turbine case and a fourth support that connects the fourth bearing to a turbine rear frame;
the third bearing comprises a squeeze film damper; and/or
the shaft has a nominal thickness between the first and second bearings, a thickness of the shaft being between 40% and 60% bigger than the nominal thickness below the fan drive turbine and up to the fourth bearing.

According to a second aspect, it is proposed an aircraft comprising at least one open rotor propulsion system according to the first aspect, wherein the open rotor propulsion system is connected to the aircraft via a pylon.

According to a third aspect, the disclosure proposes a method for disassembling an open rotor propulsion system according to the first aspect comprising the following steps:
removing a first module comprising the fan drive turbine and the shaft from the open rotor propulsion system;
removing a second module comprising the high-pressure compressor, a combustion chamber and a high pressure turbine;
removing a third module comprising the fan section, the inlet case, the ducted fan and the low pressure compressor.

In an embodiment, the method further comprises removing the second module comprises disassembling the shaft from a shaft that is connected to the low-pressure compressor.

The first bearing may be connected to the inlet case and the step of removing the third module may comprises the following substeps:
removing a fourth module comprising the ducted fan and the low pressure compressor; and
removing a fifth module comprising the fan section and the inlet case.

The present disclosure applies for example to propulsion systems having a redline (maximum speed that can be reached by the propulsion system) between 8,000 rpm and 15,000 rpm, for example of about 10,000 rpm.

### BRIEF DESCRIPTION OF THE DRAWINGS

Other features, objects, and advantages of the present disclosure will appear on reading the following detailed description and from the accompanying drawing, given by way of non-limiting example, and in which:

FIG. 1 is a cross-sectional schematic illustration of an exemplary embodiment of an open rotor propulsion system;

FIG. 2 represents an exemplary aircraft comprising open rotor propulsion systems;

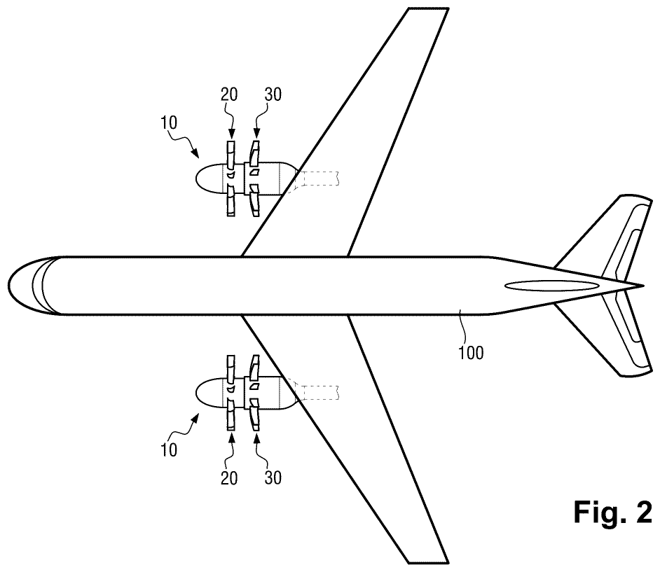

FIG. 3a is a schematic illustration of the ducted fan, wherein an exemplary configuration in accordance with a first embodiment of the first bearing and the second bearing of the fan drive turbine shaft has been represented;

FIG. 3b is a schematic illustration of the ducted fan, wherein an exemplary configuration in accordance with a second embodiment of the first bearing and the second bearing of the fan drive turbine shaft has been represented;

FIG. 4 is a schematic illustration of an open rotor propulsion, wherein a first exemplary configuration of the third bearing and fourth bearing of the fan drive turbine shaft has been represented;

FIG. 5 is a schematic illustration of an open rotor propulsion, wherein a second exemplary configuration of the third bearing and fourth bearing of the fan drive turbine shaft has been represented;

FIG. 6 is a schematic illustration of an example of an open rotor propulsion system fixed to the pylon of an aircraft according to an embodiment; and

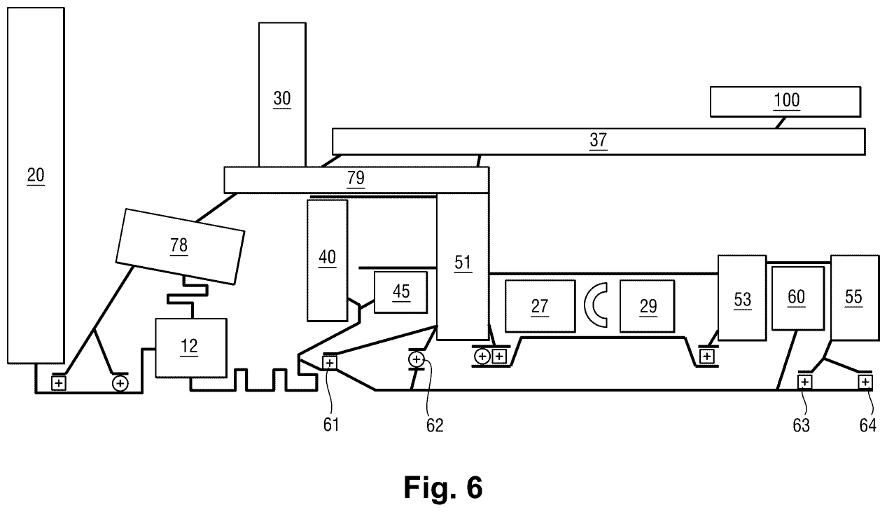

FIG. 7 represents steps of an example of method of disassembling an open rotor propulsion system according to an embodiment.

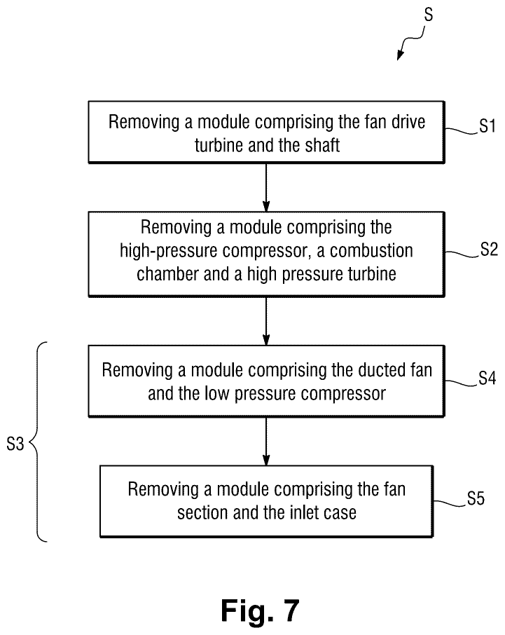

Like designations in the drawings and descriptions have been used to refer to like parts of the disclosure.

### DETAILED DESCRIPTION

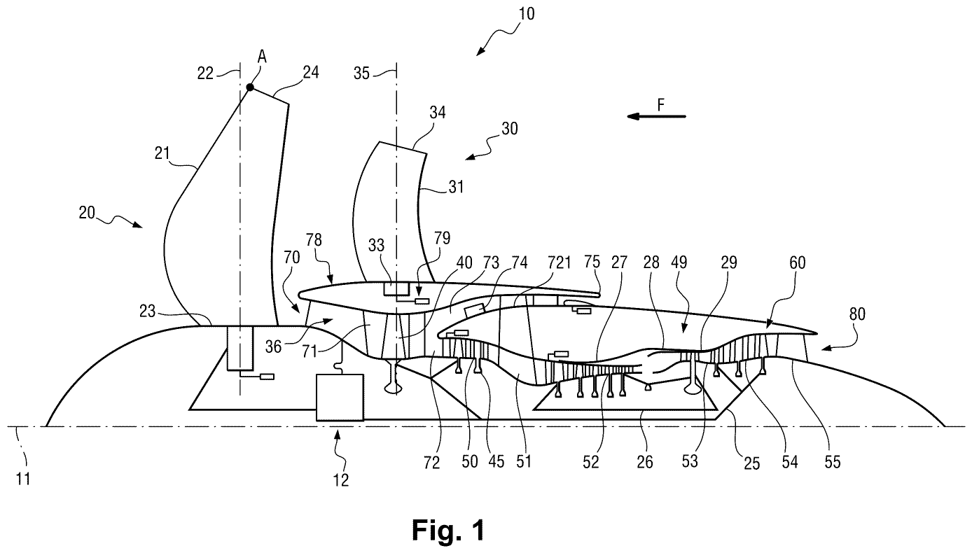

FIG. 1 shows an elevational cross-sectional view of an exemplary embodiment of an open rotor propulsion system 10 for example for propulsion of an aircraft 100. As is seen from FIG. 1, the open rotor propulsion system 10 comprises a fan section including a rotating element 20 which includes an array of fan airfoil blades 21 around a central longitudinal axis 11 of the open rotor propulsion system 10. Blades 21 are arranged in typically equally spaced relation around the centerline 11, and each blade 21 has a root 23 and a tip 24, and a span defined therebetween, as well as a central blade axis 22. Open rotor propulsion system 10 includes a gas turbine engine having a low-pressure (LP) compressor 45, or booster, a gas turbine core and a low-pressure (LP) turbine 60. Gas turbine core includes a high-pressure (HP) compressor 27, a combustor 28, and a high-pressure (HP) turbine 29 in serial flow relationship. A high-pressure (HP) shaft 26 enables the HP turbine 29 to drive the HP compressor 27. A low-pressure (LP) shaft 25 enables the LP turbine 60 to drive the rotating element 20 and the booster 45.

In the present application, upstream and downstream are defined with respect to the normal flow direction of gas through the propulsion system 10. Furthermore, the axial direction corresponds to the direction of the longitudinal axis 11, and a radial direction is a direction perpendicular to this axis 11 and passing through it. Internal and external will be used, respectively, in reference to a radial direction so that the internal part or face of an element is closer to the axis 11 than the external part or face of the same element. Finally, the planes defined herein below are all normal to the longitudinal axis 11.

The fan section of the open rotor propulsion system 10 also includes, in the exemplary embodiment of FIG. 1, a non-rotating stationary element 30 which includes an array of vanes 31 also disposed around central axis 11, and each vane 31 has a root 33 and a tip 34 and a span defined therebetween. These vanes 31 may be arranged such that they are not all equidistant from the rotating assembly, and be unshrouded (as shown in FIG. 1) or may optionally include an annular shroud or duct distally from axis 11 (axis 11 is shown in FIG. 1). These vanes are mounted to a stationary frame and do not rotate relative to the central axis 11, but may include a mechanism for adjusting their orientation relative to their axis 35 and/or relative to the blades 21. For reference purposes, FIG. 1 also depicts a forward direction denoted with arrow F, which in turn defines the forward and aft portions of the system. As shown in FIG. 1, the rotating element 20 is located forward of the gas turbine core in a “puller” configuration, and the exhaust 80 is located aft of the stationary element 30.

Open rotor propulsion system 10 may also include a power gearbox 12 which may include a gearset for decreasing the rotational speed of the rotating element 20 relative to the low-pressure turbine 60. The blades 21 of the open, unducted rotating element 20 may have a fixed pitch or blade angle, or may instead have a variable pitch or blade angle to vary thrust and blade loading during operation and, in some configurations, to provide a reverse thrust configuration for aircraft deceleration upon landing.

An annular 360 degrees inlet 70 is located between the rotating element 20 and the fixed or stationary element 30, and comprises a vane 36 that receives a path for incoming atmospheric air to enter the gas turbine core radially inwardly of the stationary element 30. Such a location may be advantageous for a variety of reasons, including management of icing performance as well as protecting the inlet 70 from various objects and materials as may be encountered in operation.

FIG. 1 illustrates what may be termed a “puller” configuration where the thrust-generating rotating element 20 is located forward of the gas turbine core. Other configurations are possible and contemplated as within the scope of the present disclosure, such as what may be termed a “pusher” configuration embodiment where the gas turbine core is located forward of the rotating element 20. A variety of architectures are shown and described in the publications number WO 2022/069834, WO 2022/018380 and US 2013/0098066 for example.

In addition to the open rotor or unducted rotating element 20 with its plurality of fan airfoil blades 21, a ducted fan 40 is included behind the open rotor rotating element 20, such that the open rotor propulsion system 10 includes both a ducted and an unducted fan which both serve to generate thrust through the movement of air at atmospheric temperature without passage through the gas turbine core. The ducted fan 40 is shown at about the same axial location as vanes 31, and radially inward of the vane roots 33. Alternatively, the ducted fan 40 may be between the vane 31 and core duct 72, or be farther forward of the vanes 31. The ducted fan 40 may be driven by the low-pressure turbine 60, or by any other suitable source of rotation, and may serve as the first stage of booster 45 or may be operated separately.

The ducted fan 40 includes an array of fan airfoil blades 41 around the central longitudinal axis 11 of the open rotor propulsion system 10. Blades 41 are arranged in typically equally spaced relation around the centerline 11, and each blade 41 has a root 43 and a tip 44, and a span defined therebetween.

In the following, the invention will be described in reference to a ducted fan 40 driven by the low-pressure turbine 60. Besides, this same low-pressure turbine 60 drives the unducted rotating element through the gearbox 12. However, in an embodiment, the unducted rotating element 20 may be driven by any other suitable source of rotation.

Air entering the inlet of the gas turbine core flows through an inlet duct 71 and then is divided behind the ducted fan 40 such that a portion flows through a core duct 72 and a portion flows through a fan duct 73. Fan duct 73 may incorporate heat exchangers 74, and exhausts to the atmosphere through an independent fixed or variable nozzle 75 aft of the stationary element 30 and outside of the gas generator core cowl 721. Air flowing through the fan duct 73 thus “bypasses” the core of the engine and does not pass through the core. Open rotor propulsion system 10 therefore includes an unducted fan formed by rotating element 20, followed by a ducted fan 40, which directs airflow into two concentric or non-concentric ducts 72 and 73, thereby forming a three-stream engine architecture with three paths for air which passes through the rotating element 20.

Since the open rotor propulsion system 10 includes both an open rotor rotating assembly 20 and a ducted fan assembly 40, the thrust output of both and the work split between them can be tailored to achieve specific thrust, fuel burn, thermal management, and acoustic signature objectives which may be superior to those of a typical ducted fan gas turbine propulsion assembly of comparable thrust class. The ducted fan assembly 40, by lessening the proportion of the thrust required to be provided by the unducted fan assembly 20, may permit a reduction in the overall fan diameter of the unducted fan assembly and thereby provide for installation flexibility and reduced weight.

Operationally, the open rotor propulsion system 10 may include a control system that manages the loading of the respective open and ducted fans, as well as potentially the exit area of the variable fan nozzle, to provide different thrust, noise, cooling capacity and other performance characteristics for various portions of the flight envelope and various operational conditions associated with aircraft operation. For example, in climb mode the ducted fan may operate at maximum pressure ratio thereby maximizing the thrust capability of stream, while in cruise mode, the ducted fan may operate at a lower pressure ratio, raising overall efficiency through reliance on thrust from the unducted fan. Nozzle actuation modulates the ducted fan operating line and overall engine fan pressure ratio independent of total engine airflow.

The open rotor propulsion system 10 comprises an engine case 49 housing the gas turbine engine aft of the ducted fan 40. The engine case 49 includes a forward frame 78 that extends immediately aft of the unducted fan 20, at the level of the inlet 70. More particularly, the forward frame 78 extends between the unducted fan 20 and the ducted fan 20 and comprises the vane 36 that faces the path for incoming atmospheric air to enter the gas turbine core radially inwardly of the stationary element 30. The inlet duct 71 is therefore housed within the forward frame 78. The forward frame 78 is a structural part of the propulsion system 10 and is supported by bearings of the unducted fan 20. In an embodiment, the gearbox 12 may be connected to the forward frame 78, optionally hung to the forward case.

The engine case 49 also includes an OGV case 79 (for Open Guide Vane case), aft of the forward frame 78, which receives the ducted fan 40. The OGV case 79 is a structural case that supports the stationary element 30. It may be noted that the fan duct 73 is incorporated into the OGV case 79.

The engine case 79 also includes a booster case 50 that houses the booster 45, an intermediate case 51, a high-pressure case 52 that houses the gas turbine core, an inter-turbine case 53, a turbine case 54 and a turbine rear frame 55, in serial flow relationship. The intermediate case 51 (or mid-frame) extends between the booster case 50 and the high-pressure case 52 and is supported by at least one forward bearing 61, 62 of the LP shaft 25. The intermediate case 51 is also a structural case of the propulsion system 10. In an embodiment, the OGV case 79 is configured to be connected to the pylon 37 of an aircraft 100 and is structurally supported by the intermediate case 51.

It may be noted here that, in the present application, a “structural” is used to define a case or a frame of the engine, which is configured to transfer loads of the propulsion system 10. In other words, a structural frame or case is a case through which axial and radial forces of the propulsion system 10 transit (such as the loads of the bearings supporting the shafts transiting through the structural case towards suspension of the engine, such as the pylon 37). As aforementioned, the forward frame 78, the OGV case 79 and the intermediate case 51 are structural cases. The forward frame 78 is configured to receive the thrust forces generated by the unducted fan 20 and transmit them to the airplane through the pylon 37. The intermediate case 51 is configured to receive the thrust forces generated by the ducted fan 40 and transmit them to the airplane through the OGV case and the pylon 37. In contrast, the booster case 50 and the high-pressure case 52 support the corresponding compressor sections and delimit the flow path within said compressor sections; however, these cases 50, 52 are not structural cases in the meaning of the present application.

As aforementioned, the LP shaft 25 is connected to and driven by the LP turbine rotor 60 and drives the booster 45, the ducted fan 40 and the unducted fan 40. The LP shaft 25 drives the booster 45 by the connection 76.

The LP shaft 25 is connected to the engine case 49 of the gas turbine engine via exactly four bearings 61, 62, 63, 64. A first and a second bearings 61, 62 support the front portion of the shaft 25. A third and a fourth bearings 63, 64 support the rear portion of the shaft 25.

The first bearing 61 is connected to one of the forward frame 78 and the intermediate case 51 and is positioned around adjacent the ducted fan 40.

The second bearing 62 is axially aft of the first bearing 61. Preferably, the second bearing 62 is positioned as far as possible from the first bearing 61, taking into account the available space below the booster case 50 and the intermediate case 51 and more particularly the connection 76 of the LP shaft 25 to the booster 45. The gravity center G2 of the second bearing 62 is axially positioned between a first plane P3 that comprises the gravity center of the booster 45 and a second plane P4 that comprises a gravity center of the intermediate case 51. In an embodiment, the gravity center G2 of the second bearing 62 extends between a plane P3′ that comprises a gravity center of the rotating part of the last stage of the booster 45 and the second plane P4. The second bearing 62 helps controlling the LP shaft mode location and the LP shaft 25 stability.

It can be noted here that only the bearing 61, 62, 63, 64 as such (including the inner and outer rings) is taken into account to determine the gravity center of a given bearing. The support that connects the outer ring of the bearing 61, 62, 63, 64 to the engine case 49 is therefore not part of the bearing 61, 62, 63, 64 as such. Besides, the front portion of the intermediate case 51 corresponds to the front connecting flange of the intermediate case 51 which is connected to the rear portion of the booster case 50.

This structural configuration of the first and second bearings 61, 62 decouples the flexural mode of the LP shaft 25 from the suspension modes of the ducted fan 40 and moves the first flexural modes of the LP shaft 25 to a transitional, unstable flight phase (such as the climb phase) or outside the operational speeds. The LP shaft 25 is therefore less sensitive to imbalance of the ducted fan 40 and deformations of the LP shaft 25 (more particularly, the maximum bending of the LP shaft 25 located at the level of the HP compressor) are reduced. Besides, due to the location of the first bearing 61 adjacent the ducted fan 40, static clearance (resulting from gravity and rotation of the LP shaft 25) will be improved. In comparison, a structure including only one bearing would have been much more complex to obtain the same advantages, since the use of two distinct bearings offers more freedom to decouple the effects.

Besides, the farthest the second bearing 62 from the first bearing 61 (typically towards the second plane), the higher the rotational speed corresponding to the flexural mode of the LP shaft 25. However, care should be taken that the LP shaft mode remains in a non-stabilized speed range (for resonance crossing the mode). This is why the second bearing 62 should be positioned such that its gravity center G2 is axially positioned between the first plane P3 and the second plane P4. Position of the second bearing 62 within this axial range may then be optimized for stability and resonance (depending for each similar architecture on parts weight, inertia, stiffness, etc.).

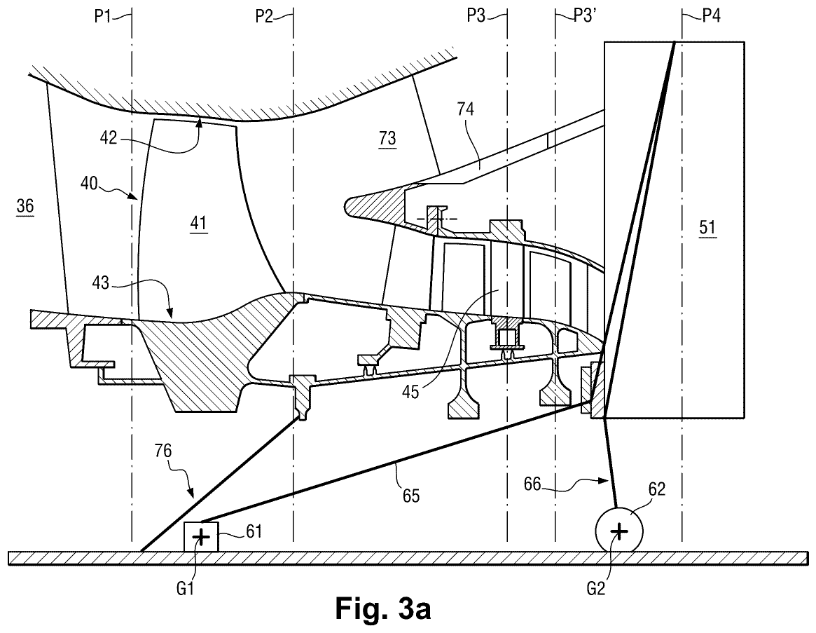

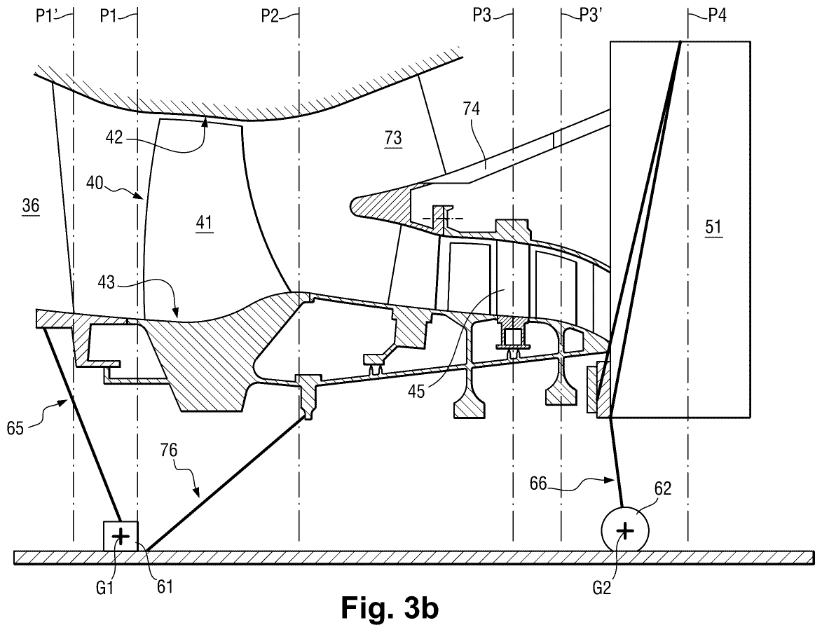

In a first embodiment (FIG. 3a), the first bearing 61 is connected to the intermediate case 51 and is positioned substantially under the ducted fan 40 (that is to say radially inwardly of the ducted fan 40). More particularly, the gravity center G1 of the first bearing 61 is axially positioned between a plane P1 that intersects a forwardmost point of a leading edge of the blades 41 of the ducted fan 40 and a plane P2 that intersects a downwardmost point of a trailing edge of said blades 41. The leading edge extends opposite the gas flow entering the ducted fan 40. It corresponds to the front part of the fan airfoil blades 41 which faces the gas flow and which divides the gas flow into a pressure flow and a suction flow. The trailing edge corresponds to the rear part of the fan airfoil blades 41, where the pressure and suction flows meet. The first bearing 61 helps controlling the ducted fan suspension mode and clearance closures under maneuvers and ducted fan unbalance.

In a second embodiment (FIG. 3b), the first bearing 61 is connected to the forward frame 78 and is positioned forward of the ducted fan 40. More particularly, the gravity center G1 of the first bearing 61 is axially positioned between the plane P1 and a plane that intersects the trailing edge of the vane 36 of the forward frame 78.

The first bearing 61 and the second bearing 62 are connected to the engine case 49 by a first support 65 and a second support 66, respectively. The first support 65 ant the second support 66 are each fixed to the outer ring of the corresponding bearing and may have a truncated cone shape. In the first embodiment described above, the first support 65 is connected to the intermediate case 51, while it is connected to the forward frame 78 in the second embodiment.

To further decouple the flexural modes from the LP shaft 25 and the ducted fan 40, a radial stiffness of the first support 65 is at least twice bigger than a radial stiffness of the second support 66. For example, the radial stiffness of the first support 65 may be between 2 and 5*10⁻⁹ m/N and the radial stiffness of the second support 66 may be between 5 and 10*10⁻⁹ m/N.

It can be noted here that the radial stiffness of the first and second supports 65, 66 is defined intrinsically, that is to say by considering the supports as such, outside the propulsion system 10. The radial stiffnesses values are therefore absolute values, not relative values, and do not depend on the environment in which they are measured, such that it is possible to integrate these supports in any propulsion system 10. The radial stiffness of a given support 65, 66 may be determined by encasing an end of the support 65, 66, the other end being free to radially move. This configuration actually reflects the configuration of the supports 65, 66 in the propulsion system 10 (the encased end corresponding to the end connected to the engine case 49 and the free end corresponding to the end connected to the corresponding bearing). The stiffness of the supports 65, 66 is then defined as the ratio between a radial force applied to the free end the radial displacement of the free end with respect to the encased end that results from this radial force.

The second support 66 may be connected to the intermediate case 51. For example, in the first embodiment, the first and second supports 65, 66 may be connected to a same attachment of the intermediate case 51. It may be noted that the position of the second bearing 26 allows deformation of the forward portion of the engine. Indeed, in operation, the unducted fan 20 pulls on the intermediate case 51 and generates a relative movement between the unducted fan 20 and the stationary element 30 that creates clearances. By positioning the second bearing 62 between the planes P3 and P4 and by connecting the support 62 to the intermediate case 51, the support 66 therefore follows the stationary element 30 and reduces the forward part clearances.

The first bearing 61 may include a roller bearing and the second bearing 62 may include a ball bearing to improve the dynamic behavior of the front portion of the shaft 25.

Optionally, the second bearing 62 may include a soft squirrel cage and a squeeze-film damper to significantly reduce the impact of the first bending mode of the LP shaft on the architecture. A squirrel cage and a squeeze-film damper are however not necessary for the first bearing 61.

The third bearing 63 is located substantially under the LP turbine 60. The fourth bearing 64 is located aft of the third bearing 63.

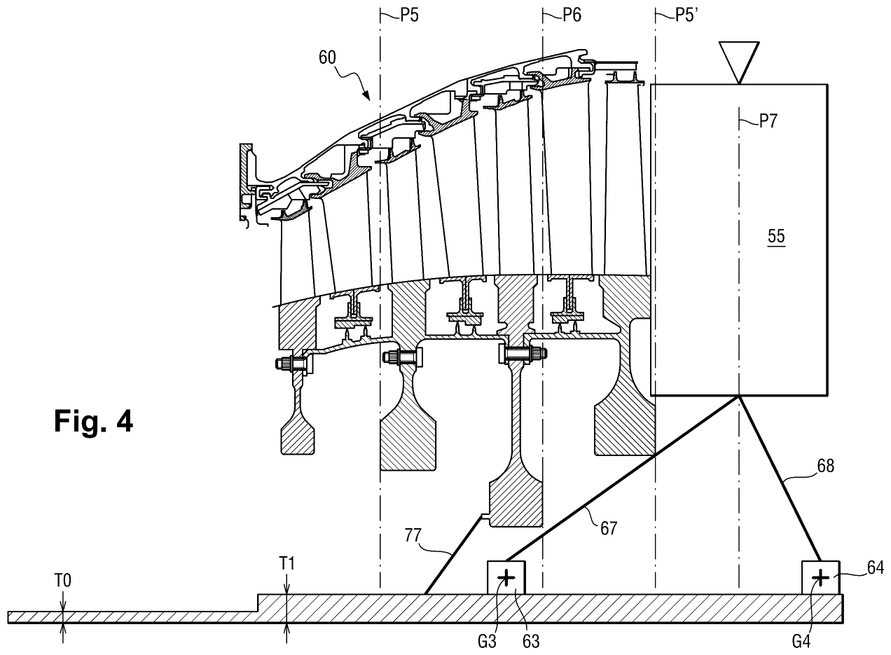

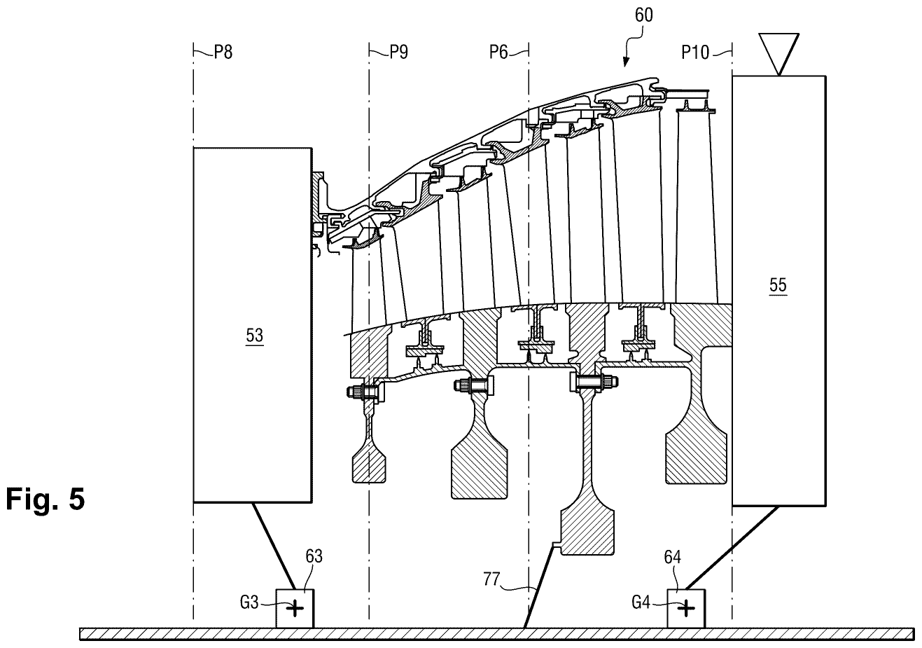

Two embodiments for locating the third and fourth bearings 63, 64 are disclosed below, with reference to FIGS. 4 and 5 respectively. In both embodiments, the third and fourth bearings 63, 64 are spaced apart to reduce static clearance under maneuvers. For example, the third and fourth bearings 63, 64 may be spaced apart by a distance of at least 100 mm and at most 500 mm.

In the first embodiment (see FIG. 4), the gravity center G3 of the third bearing 63 is axially located close to a downstream plane P6 that comprises a gravity center of the rotor of the LP turbine rotor (that is to say the turning vanes of the LP turbine, but not the stator vanes nor the portion of the LP shaft, which is connected to the rotating vanes of the LP turbine rotor). For example, to take into account part assembly constraints and optimize clearances closure and dynamics mode/stability, the gravity center G3 of the third bearing 63 may axially extend between an upstream plane P5 that intersects a forwardmost point of a stage of the LP turbine 60 which is immediately forward of the downstream plane P6 and a downstream plane P5′ that intersects a rearwardmost point of a stage of the LP turbine 60 which is immediately rearward of the downstream plane P6. For example, when the gravity center of a 4-stages LP turbine 60 intersects the third stage of the LP turbine 60 (see FIG. 4), the third bearing 63 may be axially located below the rotating part of the second stage of the LP turbine 60. It can be noted that the location of the third bearing 63 may be restrained by the connection 77 of the LP shaft 25 to the LP turbine 60 rotor, which may be located downstream of the upstream plane P5. In that case, the third bearing 63 may be axially located upstream of the gravity center of the LP turbine 60, up to the connection 77 of the LP shaft 25 to the LP turbine 60 rotor.

This configuration of the third bearing 63 reduces the length portion of the LP shaft 25 that affects the LP shaft modes, such that the LP shaft length between the second and third bearings 62, 63 may be reduced. The rotational speed of the LP shaft 25 may therefore be increased, such that the theoretical instable speed range of the LP shaft 25 is reduced. Locating the third bearing 63 radially inwardly of the gravity center of the LP turbine 60 also reduces static clearance resulting from gravity.

Preferably, the fourth bearing 64 is positioned as far as possible from the third bearing 63, taking into account the available space below the LP turbine 60 case and the turbine rear frame 55. For example, the fourth bearing 64 may extend under the turbine rear frame 55, such as in the plane P7 that contains the gravity center of the turbine rear frame 55 or even downstream that plane P7.

The third bearing 63 affects the LP shaft modes and stability, and helps controlling clearance closure under inertial loads. The fourth bearing 61 helps controlling clearance closure under dynamic loads.

The third and fourth bearings 63, 64 are connected to the engine case 49 through respective supports 67, 68, each support 67, 68 being connected to the turbine rear frame 55. Optionally, the supports 67, 68 may both be connected to a same attachment of the turbine rear frame 55.

In the second embodiment (FIG. 5), a gravity center G3 of the third axially extends between a plane P8 that intersects a forward portion of the inter-turbine case 54 and a plane P9 that intersects a rotating part of the first stage of the LP turbine 60. The third bearing 63 may therefore extend upstream of the connection 77 of the LP shaft 25 to the LP turbine 60 rotor. In this configuration, the third bearing may be connected to the inter-turbine case 53. Therefore, the constraints related to the connection of the third bearing 63 to the turbine rear frame 55 are removed. Besides, this configuration of the third bearing 63 reduces the length of the portion of the LP shaft 25 that affects the LP shaft modes, such that the LP shaft length between the second and third bearings 62, 63 may be reduced. Reducing the instability speed range (between the LP shaft mode and the maximum speed range LP rotor) is also easier due to reduction of the distance between the bearings 62 and 63.

In this configuration, the third bearing 63 helps controlling LP shaft mode location and instability.

Here again, the fourth bearing 64 is positioned as far as possible from the third bearing 63. However, this fourth bearing 64 should not extend too far under the turbine rear frame 56 to limit the loads applied to the third and fourth bearings 63, 64. For example, the gravity center G4 of the fourth bearing 64 may axially extend between the plane P3 that comprises the gravity center of the LP turbine 60 and a plane P10 that intersects a forwardmost portion of the turbine rear frame 56.

The fourth bearing 64 location helps controlling unbalanced loads and clearance closures (due to unbalances and static clearance under inertial loads).

In this embodiment, the support 67 of the third bearing 63 may be connected to the inter-turbine case 54 and the support 68 of the fourth bearing 64 may be connected to the turbine rear frame 56.

In both embodiments, the third bearing 63 may include a squirrel cage and a squeeze film damper (not shown in the drawings) to further reduce amplitude of the flexural mode of the LP shaft 25 by damping the loads applied to the bearings and limiting clearance consumptions. The squirrel cage and the squeeze film will also dampen the resonance amplitude and avoid potential instabilities of the LP shaft.

Besides, the thickness of the LP shaft 25 may be increased along the LP turbine 60 to reduce deformation energy in the LP shaft 25 by transferring said deformation energy to the engine case 49, and therefore avoid that this deformation energy be contained within the LP shaft 25. For example, the LP shaft 25 may have a nominal thickness T0, which corresponds to the thickness of the shaft 25 between the first and second bearings 61, 62. The thickness T1 of the LP along the LP turbine 60 is then 50% bigger than the nominal thickness T0. For example, the thickness of the LP shaft may be increased along the whole axial length of the LP turbine 60, that is to say from the plane that intersects the first rotating part of the LP turbine 60 to the plane that intersects the last stationary element of the LP turbine 60. Optionally, in the first embodiment of the third and fourth bearings 63, 64, the thickness may be increased up to the fourth bearing 64.

For example, the thickness of the LP shaft 25 having a nominal thickness T0 of about 35 mm may be increased by about 50%.

It may be noted that, even if the architecture may be more sensitive to aerodynamic loads due to the support of the third and fourth bearings 63, 64, rotor clearance is increased. The position of the bearings 61, 62, 63, and 64 is however a compromise that reduces rotor clearance by stiffening the shafts and the rotors, despite the efforts received by the ducted fan 40, which are due to inhomogeneity of air entering the inlet duct 71, shocks received by the unducted fan 20, maneuvering and the amplitude of the flexural modes of the LP shaft 25.

With regard to the exemplary embodiments depicted herein, either single or multiple gearboxes may be employed. A gearbox between the unducted fan and the ducted fan may have a ratio of between about 2:1 and 12:1, and a second gearbox between the booster and the ducted fan with a traditional HP turbine. Another configuration may utilize two counter-rotating turbines with two LP shaft 25s coming forward, or counter-rotating turbines may drive a common LP shaft 25 coming forward. In each case, an aft gearbox may have a ratio between about 2:1 and 5:1.

The total desired thrust produced by the gas turbine engine may be varied as needed to suit the operational conditions and flight envelope for the associated aircraft. The maximum design work split between the unducted fan and the ducted fan may also be varied as needed, such as, for example, in certain embodiments up to approximately 60% of the total thrust may be produced by the ducted fan to minimize the engine diameter or noise, while in another embodiment only a few percent of the total thrust if the primary function of the ducted fan stream is as a thermal sink. Pressure ratios for the aft ducted fan may be less than about 2.5.

The propulsion system 10 may be formed of several modules, which may be disassembled by blocks for inspection and maintenance. The propulsion system may include:
a first module comprising the fan drive turbine 60 and the LP shaft 25;
a second module comprising the high-pressure section, which includes the high-pressure compressor 27, the combustion chamber and the high pressure turbine;
a third module comprising the fan section, the inlet case 70, the ducted fan 40 and the low pressure compressor

Disassembly of the propulsion system 10 may include the following steps:
removing from the open rotor propulsion system 10 a first module comprising the fan drive turbine 60 and the shaft 25;
removing a second module comprising the high-pressure compressor 27, a combustion chamber and a high-pressure turbine;
removing a third module comprising the fan section, the forward frame 78, the ducted fan 40 and the low-pressure compressor 45.

In that purpose, the LP shaft comprises a first portion, which is connected to the rotor of the LP turbine, and a second portion, which is connected to the LP compressor. The first and second portions of the LP shaft 25 are connected by fasteners, such as splines and nuts. During disassembly, the first module first is withdrawn by pulling said first module away from the second module. The second module is then disassembled from the third module by disconnecting the first portion and the second portion of the LP shaft 25 and pulling said second module away from the third module. Each module may then be inspected, repaired and/or replaced separately.

When the first bearing 61 is connected to the intermediate case 51, the third module may be split into two sub-modules, i.e.:
a first sub-module comprising the ducted fan 40 and the low pressure compressor 45; and
a second sub-module comprising the fan section and the forward frame 78.

Indeed, connection of the first support 65 to the forward frame allows separation of the first and second sub-modules without opening the sump that contains the first bearing 61.

The first and second sub-modules may be connected to each other by means of splines and nuts.

During disassembly, the first and second sub-module may be disconnected after separation of the third module from the second module.

1. An open rotor propulsion system comprising:
a fan section including an unducted rotating element comprising a first array of fan airfoil blades and a non-rotating stationary element;
an forward frame housing an inlet duct including an inlet located between the unducted rotating element and the non-rotating stationary element;
a ducted fan positioned aft the unducted rotating element within the inlet duct, wherein the ducted fan comprises a second array of fan airfoil blades;
a fan duct and a core duct extending aft the ducted fan;
an engine positioned within the core duct and comprising a low-pressure compressor, a high-pressure compressor, an intermediate case located between the low-pressure compressor and the high-pressure compressor, a fan drive turbine and a shaft connected to the fan drive turbine and configured to drive the ducted fan; and
four bearings configured to support the shaft with respect to an engine case,
wherein the four bearings comprise:
a first bearing connected to one of the forward frame and the intermediate case; and
a second bearing aft of the first bearing and comprising a gravity center axially positioned between a first plane that comprises a gravity center of the low-pressure compressor and a second plane that comprises a gravity center of the intermediate case.

2. The open rotor propulsion system of claim 1, wherein the first bearing is positioned radially inwardly of the ducted fan.

3. The open rotor propulsion system of claim 2, wherein the first bearing is connected to the intermediate case.

4. The open rotor propulsion system of claim 2, wherein a gravity center of the first bearing is axially positioned between a third plane that intersects a forwardmost point of a leading edge of the unducted fan and a fourth plane that intersects a downwardmost point of a trailing edge of the unducted fan.

5. The open rotor propulsion system of claim 1, wherein the first bearing is forward of the ducted fan.

6. The open rotor propulsion system of claim 1, wherein the first bearing comprises a roller bearing and the second bearing comprises a ball bearing.

7. The open rotor propulsion system of claim 6, wherein the second bearing includes squirrel cage and a squeeze-film damper.

8. The open rotor propulsion system of claim 1, wherein the gravity center of the second bearing extends between a fifth plane that comprises a gravity center of a rotating part of a last stage of the low-pressure compressor and the second plane.

9. The open rotor propulsion system of claim 1, further comprising a first support that connects the first bearing to the one of the inlet case and the intermediate case, and a second support that connects the second bearing to the engine case,
wherein a radial stiffness of the first support is at least twice bigger than a radial stiffness of the second support.

10. The open rotor propulsion system of claim 1, wherein the four bearings further comprise:
a third bearing positioned radially inwardly of the fan drive turbine; and
a fourth bearing, positioned aft of the third bearing.

11. The open rotor propulsion system of claim 10, wherein a gravity center of the third bearing axially extends between a sixth plane that intersects a gravity center of the fan drive turbine and a seventh plane that intersects a rotating part of a stage of the fan drive turbine which is immediately forward of the sixth plane.

12. The open rotor propulsion system of claim 10, further comprising a turbine rear frame aft of the fan drive turbine,
wherein the fourth bearing extends radially inwardly of the turbine rear frame.

13. The open rotor propulsion system of claim 10, further comprising supports that connect the third bearing and the fourth bearing to a turbine rear frame.

14. The open rotor propulsion system of claim 10, further comprising a high-pressure turbine that drives the high-pressure compressor and an inter-turbine case that extends between the high-pressure turbine and the fan drive turbine,
wherein a gravity center of the third bearing axially extends between a eighth plane that intersects a forward portion of the inter-turbine case and a ninth plane that intersects a rotating part of a first stage of the fan drive turbine.

15. The open rotor propulsion system of claim 10, wherein a gravity center of the fourth bearing extends between a sixth plane that intersects gravity center of the fan drive turbine and a tenth plane that intersect a forwardmost portion of a turbine rear frame.

16. The open rotor propulsion system of claim 14, further comprising a third support that connects the third bearing to the inter-turbine case and a fourth support that connects the fourth bearing to a turbine rear frame.

17. The open rotor propulsions system of claim 10, wherein the third bearing comprises a squeeze film damper.

18. The open rotor propulsion system of claim 10, wherein the shaft has a nominal thickness between the first and second bearings, a thickness of the shaft being between 40% and 60% bigger than the nominal thickness below the fan drive turbine and up to the fourth bearing.

19. An aircraft comprising:
at least one of the open rotor propulsion system according to claim 1, and
a pylon,
wherein the open rotor propulsion system is connected to the aircraft via a the pylon.

20. A method for disassembling the open rotor propulsion system according to claim 1, the method comprising:
removing a first module comprising the fan drive turbine and the shaft from the open rotor propulsion system;
removing a second module comprising the high-pressure compressor, a combustion chamber and a high pressure turbine;
removing a third module comprising the fan section, the inlet case, the ducted fan and the low pressure compressor.

21. The method of claim 20, wherein removing the second module comprises disassembling the shaft from a shaft that is connected to the low-pressure compressor.

22. The method of claim 20, wherein the first bearing is connected to the inlet case, and removing the third module comprises:
removing a fourth module comprising the ducted fan and the low pressure compressor; and
removing a fifth module comprising the fan section and the inlet case.
